(19) United States
(12) Patent Application Publication
(10) Pub. No.: US 2007/0121532 A1
(43) Pub. Date: May 31, 2007

(54) Application specific encoding of content

(75) Inventors: Stephan Wenger, Tampere (FI); Umesh Chandra, Allen, TX (US); Miska Hannuksela, Ruutana (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/289,663

(22) Filed: Nov. 28, 2005

(51) Int. Cl. H04B 7/00

(52) U.S. Cl. 370/310

(57) ABSTRACT

Transmitting content and tailoring encoding according to application requirements. To change encoding, choosing an operation point for encoding content depending on the application receiving the content, sending data representative of the chosen operation point to a sender of the content, receiving data representative of an operation point from a receiver of the content, adapting encoding of the content depending on the received data representative of the operation point, encoding the content based on the operation point, sending the encoded content to the receiver, and receiving the encoded content wherein the encoding is based on the operation point is provided.

### TECHNICAL FIELD

This patent application relates in general to encoding content depending on the receiving application. The application further relates to signaling of application specific sub-profiling for media transmission in multimedia communication systems.

### BACKGROUND OF THE INVENTION

Today, a number of signaling systems exist that enable multimedia communication. For example, ITU-T Rec. H.320, and the related ITU-T Rec. H.242, H.230, specify the signaling for ISDN-based video conferencing systems. Further, Internet Engineering Task Force's Session Initialization Protocol (SIP), also known as RFC 3261, are related to audio and multimedia calls over Internet Protocol. A Real Time Streaming Protocol (RTSP), also known as RFC 2326 is an open standard for the signaling in streaming environments. All of these signaling protocols define communication between a sender and a receiver of content. The sender and receiver negotiate transmission parameters using these protocols. References to the codecs for encoding of content are defined within the protocols and their use is negotiated between the communication partners.

The operation point of codecs, and especially encoders, depends on the application in use. An encoder used in a conversational application, such as, for example, video conferencing, is tuned for example to low delay and high error resilience. An encoder in a streaming system, on the other hand can use high latency mechanisms, but still requires error resilience.

When the encoded media is stored, for example on a DVD, the normal operation point of an encoder would be to use high latency mechanisms and no error resilience. In the field of audio, similar observations can be made. An MP3 audio decoder employed in an IP based streaming system usually has error concealment enabled, which allows the system to tolerate a certain amount of network losses in the audio stream without severe implications to the user perceived quality. An MP3 audio decoder employed in playback devices, for example in a solid-state MP3 player, does not require or use such a mechanism, as it can rely on the error free bit stream.

The trend away from single-use devices makes the provisioning of flexible codecs more and more important. It is necessary to account for resources being used by an encoder or decoder. If, for example, a video encoder reserves a large amount of memory for a low latency, high error resilience encoding, this memory is not available for a game running in parallel. Similarly, if an audio decoder provisions a large percentage of CPU cycles for error concealment, these CPU cycles are not available for other tasks.

The use of a set of encoding and decoding tools appropriate for the application is therefore beneficial.

### BRIEF SUMMARY OF THE INVENTION

According to one aspect of the invention, there is provided a method for receiving encoded content, the method comprising determining at least at the beginning of content transmission, and/or dynamically during content transmission, an operation point for encoded content depending on the application receiving the content, wherein determining an operation point for encoding content comprises defining at least one parameter specifying the application, sending data representative of the determined operation point to a sender of the content, and receiving the encoded content wherein the encoding is based on the operation point.

It has been found, that receiver to sender communication may enhance a quality of encoding of content, based on the applications the content is used for. The application departs from the assumption that the used codecs are tailored towards one single application running on the receiving device. In multi-use devices, different applications may use the same content, but have different requirements for the encoding of the content. The invention utilizes this by signaling from the receiver of content to the sender of content the application the content is used for and for enabling the encoder to tailor the codec for the actual application running on the device. According to the invention, it becomes possible to signal that the media stream is going to be used for a certain application. Therefore, the encoding codec can be run with a different operation point. This saves resources on the receiving device and leads to an optimal performance.

The signaling according to embodiments differs from the coding and transport mechanisms commonly negotiated during capability exchange in usual transmission systems. For example, both H.245 and SIP environments allow signaling the use of B pictures in a videoconference application. However, without any signaling of the intended use of the media stream, which is provided according to the present application, an intelligently implemented sender will never use those tools, even when allowed, as they are sub-optimal for the implicitly assumed application.

According to embodiments, the operation point may define at least one of the encoding parameters; maximum latency; maximum error resilience; forward error correction code; maximum buffering delay; bitrate; jittering; order of decoded data in output order. This allows tailoring the encoding coded to the application, which uses the codec. The different parameters may result in different quality properties of the decoded content. Because different applications may require different properties of the received content, tailoring these parameters allows setting the operation point of the codec optimal for the corresponding application.

Embodiments provide choosing the operation point independent of channel conditions. The operation point may be selected solely based on the information about the receiving application. The operation point is not adjusted to current channel characteristics.

Choosing the operation point and sending data representative of the chosen operation point is carried out at least at the beginning of content transmission, or dynamically during content transmission, according to embodiments. During transmission setup, the operation point may be set. Changing the application during media transmission may, however, be supported as well. In that case, a change in the application may cause the operation point to be adjusted and thus signaling this new operation point to the sender of content.

Further, embodiments provide defining parameters specifying the application. For example, sender and receiver may have agreed on a standardized identification of the supported applications. The application information may be conveyed through the network using the parameters. These parameters may identify in clear text or in encoded text the application on the receiving side.

The coding is channel independent. Embodiments provide source encoding the content. The channel coding may be set according to channel properties, but the content may also be source coded depending on the selected operation point of the codec.

According to embodiment, sending data representative of the chosen operation point may comprise sending a value descriptive of the overall delay at the receiving application. This value may account for the buffering delays of all the foreseen processing steps in the receiving application, including forward error correction code decoding, de-interleaving, i.e. from transmission order to decoding order, smoothing out bitrate variations of the content bitrate—compared to the transmission bitrate, and ordering of decoded data in output order.

Another aspect of the invention is a method for sending encoded content, the method comprising a sender receiving data representative of an operation point for encoded content depending on the application receiving the content, the data representative of the operation point comprising at least one parameter specifying the application, adapting encoding of the content depending on the received data representative of the operation point, encoding the content based on the operation point, and sending the encoded content to the receiver.

A further aspect of the invention is a method for transmitting content with determining within a receiver of content at least at the beginning of content transmission, and/or dynamically during content transmission, an operation point for encoded content depending on the application receiving the content, wherein determining an operation point for encoding content comprises defining at least one parameter specifying the application, sending data representative of the chosen operation point to a sender of the content, receiving within a sender of content the data representative of an operation point for encoded content depending on the application receiving the content, the data representative of the operation point comprising the at least one parameter specifying the application, adapting encoding of the content depending on the received data representative of the operation point, encoding the content based on the operation point, sending the encoded content to the receiver, and receiving in the receiver the encoded content wherein the encoding is based on the operation point.

Yet, another aspect is an electronic device for receiving encoded content comprising an application detection unit for determining at least at the beginning of content transmission, and/or dynamically during content transmission, an operation point for encoded content depending on the application receiving the content, wherein determining an operation point for encoding content comprises defining at least one parameter specifying the application, a sending unit for sending data representative of the determined operation point to a sender of the content, and a reception unit for r receiving the encoded content wherein the encoding is based on the operation point.

Another aspect of the application is an electronic device for sending encoded content comprising a receiving unit for receiving data representative of an operation point for encoded content depending on the application receiving the content, the data representative of the operation point comprising at least one parameter specifying the application, an encoding unit for adapting encoding of the content depending on the received data representative of the operation point, and a sending unit for sending the encoded content to the receiver.

Another aspect of the invention is A computer program product comprising one or more machine-readable media that store instructions which, when executed, cause one or more machines to receive encoded content, the instructions causing the one or more machines to determine at least at the beginning of content transmission, and/or dynamically during content transmission, an operation point for encoded content depending on the application receiving the content, wherein determining an operation point for encoding content comprises defining at least one parameter specifying the application, send data representative of the determined operation point to a sender of the content, and receive the encoded content wherein the encoding is based on the operation point.

A further aspect of the invention is A computer program product comprising one or more machine-readable media that store instructions which, when executed, cause one or more machines to send encoded content, the instructions causing the one or more machines to receive receiving data representative of an operation point for encoded content depending on the application receiving the content, the data representative of the operation point comprising at least one parameter specifying the application, adapt encoding of the content depending on the received data representative of the operation point, encode the content based on the operation point, and send the encoded content to the receiver.

Eventually, another aspect of the invention is A system for transmitting content comprising an electronic device for receiving encoded content comprising an application detection unit for determining at least at the beginning of content transmission, and/or dynamically during content transmission, an operation point for encoded content depending on the application receiving the content, wherein determining an operation point for encoding content comprises defining at least one parameter specifying the application, a sending unit for sending data representative of the determined operation point to a sender of the content, and a reception unit for r receiving the encoded content wherein the encoding is based on the operation point, and an electronic device for sending the encoded content comprising a receiving unit for receiving data representative of an operation point for encoded content depending on the application receiving the content, the data representative of the operation point comprising at least one parameter specifying the application, an encoding unit for adapting encoding of the content depending on the received data representative of the operation point, and a sending unit for sending the encoded content to the receiver.

These and other aspects of the invention will become apparent from and elucidated with reference to the following figures.

### BRIEF DESCRIPTION OF THE DRAWINGS

FIG. 1 A system for transmitting application specific encoded content according to embodiments;

FIG. 2 A flowchart of a method for initializing transmission of application specific encoded content according to embodiments;

FIG. 3 A flowchart of a method for dynamically changing the operation point for encoding content according to embodiments;

### DETAILED DESCRIPTION OF THE INVENTION

Prior art signaling systems in multimedia communication environments assume that the media codecs are tailored and tuned towards certain, fixed applications. It is not possible to signal that the media stream is going to be used for a different application with a different media codec operation point. This unnecessarily wastes resources and leads to a sub-optimal performance.

For example, within a video conferencing system, where it is known that the output of the video decoder is not observed by a human in real time, but is being recorded for later review, which could be used for surveillance purposes, the delay requirements are not strict. In case the encoder knew that the decoder has less strict requirements of low delay, it could employ high delay video compression codec tools, for example, B frames, which would allow for a higher quality of the reproduced stream without additional network bandwidth. Audio coding within this application does not require low delay. In contrast to sending the audio content using low delay codecs in the packetization, e.g. without interleaving, which is employed in usual video conferencing applications, interleaving can be used in the surveillance case and the reproduced audio quality in case of losses can be improved.

It is known that, for point-to-point video conferencing applications, feedback-based repair is a very efficient error control mechanism; however, feedback-based repair cannot easily be used in massive multipoint applications. According to Prior Art, a Multipoint Control Unit (MCU) used in massive multipoint applications would hide from the sending videoconference system the fact that it feeds many receivers. The MCU would perform a transcoding of the media stream received from the sender to form error resilient streams, which are then sent to the receivers. However, if the application would be signaled to the sender, the sender would itself form inherently error resilient streams, so avoiding transcoding and the resulting additional delay and loss of quality.

The invention presented encompasses a mechanism to signal a media codec and its associated packetization mechanisms to work at an operation point which is not the implicit operation point of the media codec, chosen in prior art systems, for the application in which the signalling mechanism is commonly used. Both one-time signalling during capability exchange and dynamic changes during the lifetime of a connection are supported.

In the following, the application will be described in more detail.

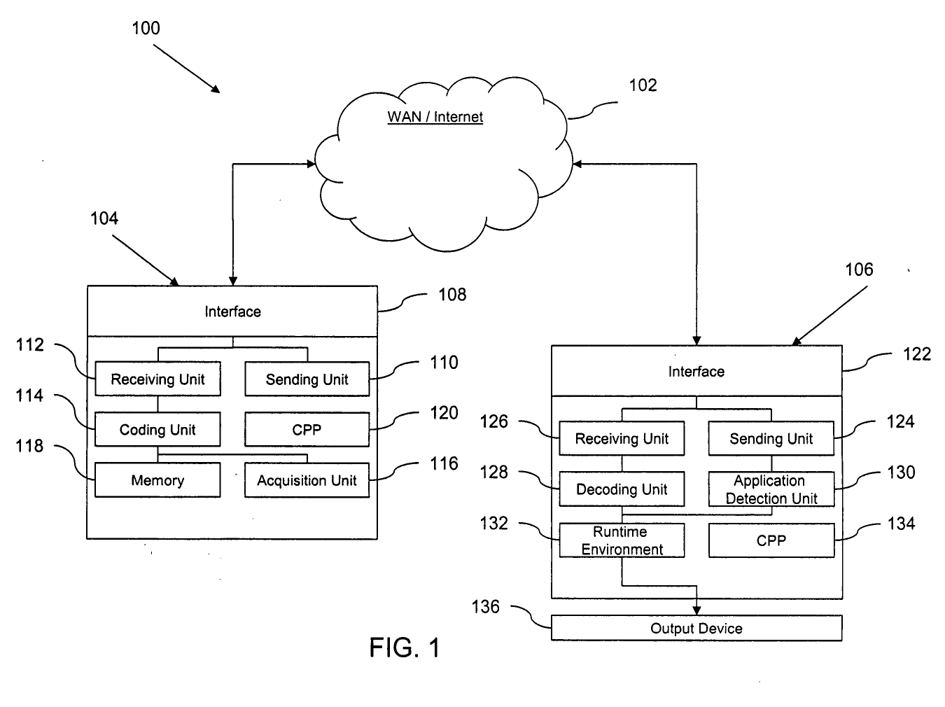

FIG. 1 illustrates schematically a system 100 for providing application specific encoding of content.

Illustrated is a transmission network 102, which can be a Wide Area Network, a local area network, an IP based network, a wireless communication network, a combination of one or more of the aforementioned networks, and the like.

Connected to this network 102 is a content sending module 104. The content sending module 104 can be a service provider computer, a videoconferencing system, a database, a video/audio supplier, a mobile communication unit, or any other means capable of acquiring and sending content to a receiving module.

Further connected to the network 102 is a content receiving module 106. The content receiving module 106 can be any kind of host computer, videoconferencing system, display device, storage and playback device, mobile communication device, or any other means capable of playing back and/or storing content.

The content sending module 104 comprises an interface 108, a sending unit 110, a receiving unit 112, a coding unit 114, a data acquisition unit 116, memory means 118, and a computer program product 120. When executed on the content sending module 104, the computer program stored in the computer program product 116 may cause the units 108-118 to perform as will be described below.

The interface 108 may be any means to connect to the network 102 and to exchange data with the network 102. The interface 108 supports communication protocols and may allow channel coding of data.

The sending unit 110 may send encoded content via interface 108 and network 102 to receiving module 106.

The receiving unit 112 may receive from receiving module 106 via network 102 and interface 108 data representative of an operation point of a codec for coding content.

The coding unit 114 may encode content with a codec operated at the operation point received on receiving unit 112.

The content acquisition unit 116 may acquire content. This may be image capturing, i.e. a video camera of a video conferencing system or a surveillance system. It may also be a sound acquisition unit, or any means capable of acquiring content.

The memory means 118 may store content, e.g. video content, audio content, multimedia content and may provide this content to be sent to the reception module. The memory means 118 may comprise a database, a hard disk, a DVD, or RAM/ROM memory or any combination of these.

The receiving module 106 comprises an interface 122, a sending unit 124, a receiving unit 126, a decoding unit 128, an application detection unit 130, a runtime environment 132, and a computer program product 134 and in some embodiments, memory means (not in figure). When executed on the content receiving module 106, the computer program stored in the computer program product 13.4 may cause the units 122-132 to perform as will be described below.

The interface 122 may be any means to connect to the network 102 and to exchange data with the network 102. The interface 122 supports communication protocols and may allow channel coding of data.

The receiving unit 126 may receive encoded content from sending module 104 via the network 102 and interface 122.

The sending unit 124 may send to sending module 104 via network 102 and interface 122 data representative of an operation point of a codec for coding content.

The runtime environment 132 is capable of running an application, such as, for example, a videoconferencing system, a surveillance system, a recording system, a playback system, and the like. Via output device 136, the content can be played back to the user, recorded, or used as wished and required by the application. The output device can be an audio system, a video display, or the like.

The operation of the system 100 will be described hereinafter.

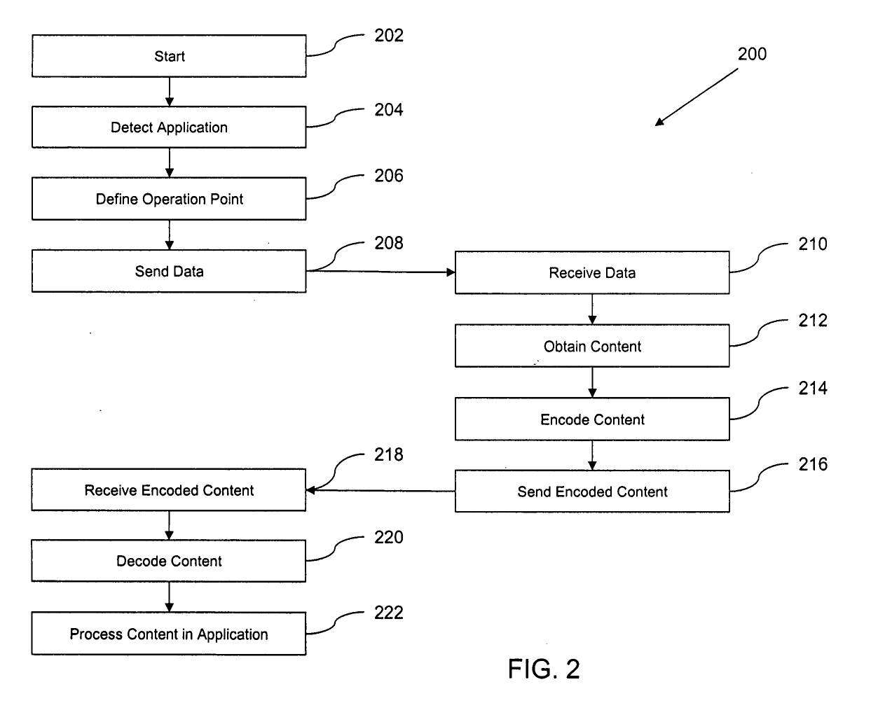

FIG. 2 illustrates a method 200 for providing transmission of application specific encoded content.

In the following, an example of data representative of the operation point employing a Session Description Protocol (SDP) syntax is provided.

It may be possible to define an SDP attribute APP_Delay, which may denote the maximum latency of the content, i.e. a media stream that is acceptable for the application running in the receiving module 106.

For example, sending module 104 wishes to set up a bi-directional video call with receiving module 106. For that reason, sending module may send an initial Session Initiation Protocol (SIP) INVITE message with a message body as given below

v=0

o=NRC 289084412 2890841235 IN IP4 123.124.125.1

s=Demo

c=IN IP4 123.124.125.1

m=video 5001 RTP/AVP 99

a=rtpmap 99H2.63/90000

m=audio 6001 RTP/AVP 32

a=rtpmap:32 AMR

to receiving module 106.

Receiving module 106 wishes to take the call.

After initialization (202), receiving module 106 may try to determine (204), which type of application is running, in the embodiment, which video call application is used. In the example, receiving module 106 detects that the application wants to record the video (and not audio) and hence it is ready to accept more delay so that the recorded video quality is good. Determining the type of application may be done by selecting, detecting, or choosing an application running in the runtime environment.

Depending on the determined (204) application, an operation point of a media codec is defined, at which the sender of the media content shall encode the content. For example, the determined (204) application requires a certain maximum latency in a media bit stream. This latency information could be expressed, for example, in the form of milliseconds, audio frames, or number of minimum picture intervals.

In order to inform the sending module 104 about the possible longer delay, receiving module 106 can define in a Session Description Protocol (SDP) message that it can withstand higher delay values. With this information the operation point of the encoder may be defined (206). The data representative of the operation point may be sent (208) from the receiving module 106 to the sending module 104 using APP_DELAY SDP attributes. The message may look like:

v=0

o=NRC 289084412 2890841235 IN IP4 123.124.125.1

s=Demo

c=IN IP4 172.19.12.127

m=video 5001 RTP/AVP 99

a=rtpmap 99H2.63/90000

a=APP_DELAY:500

m=audio 6001 RTP/AVP 98

a=rtpmap:98 AMR

In this example, the receiving module 106 may advise the sending module 104 that it can, based on its knowledge of the application, tolerate 500 ms of latency.

The information defining the operation point of the codec may consist of one value, which indicates the buffering delays of all the foreseen processing steps in the receiving module 106, including forward error correction code decoding, de-interleaving (from transmission order to decoding order), smoothing out bitrate variations of the media bitrate (compared to the transmission bitrate), and ordering of decoded data in output order. This information may also include de-jittering and processing delays.

Alternatively, the information defining the operation point of the codec may consist of a set of values, each indicating the buffering delays for independent buffering steps in the receiver.

The information may be derived relative to one or more pre-defined hypothetical buffering models of the application running in the runtime environment 132, or the information may be derived from the initial buffering delay according to these hypothetical buffering models.

The information can be conveyed either once during setup or perhaps more than once during a lifetime of the connection. As illustrated in FIG. 1, after having defined the operation point (206), the data representative of this operation point is sent (208) to the sending module 104, which receives (210) this data.

Sending module 104 receives (210) this message via receiving unit 112. Receiving unit 112 instructs coding unit 114 to obtain (212) the content from acquisition unit 116, which may be a camera. It may also be possible to acquire the content from memory 118.

Coding unit 114 encodes (214) the video stream with a video codec operating at the operation point defined by the message received. Because the operation point of the codec is chosen with a higher possible delay, the video quality may be improved. Sending module 104 sends (216) via sending unit 110 the encoded content to receiving module 106. The encoded content is received (218) in receiving module 106 within receiving unit 126.

The operation point of the codec is known within receiving module 106 and the decoding unit 128 is instructed to decode (220) the received encoded content accordingly. The decoded content is then processed in the application and may be forwarded to output device 136.

It may also be possible, that each module 104, 106 comprises sending and receiving capabilities, e.g. for a bi-directional video call. In that case each party may specify the application delay requirements and operation points of the encoding on the corresponding other side of the communication, since both are senders and receivers.

Instead of defining one value for the application delay, it may be possible to define SDP attributes, which denote the delay for independent decoding processing steps like FEC decoding, de-interleaving, ordering of decoded data etc. This set of SDP attributes can be declared in the SDP message as described in the above example of APP_DELAY attribute.

In another possible embodiment, the receiving module 106 may signal the sending module 104 its desire for certain error resilience strength. The sending module 104 can react to those requests, for example, by means such as increasing the Forward Error Correction (FEC) strength if FEC is employed in the coding unit 114, by the use of error resilient coding, such as video intra picture or intra macroblock refresh, by means of audio interleaving or any other means suitable for increasing the error resilience strength of the encoded signal.

The error resilience strengths could be expressed, for example, by an integer value N indicating the requested tolerance against N percent Real-Time Transport Protocol (RTP) packet loss. Other measures for error resilience strength could include a float value F indicating the tolerance against bit errors of a probability F assuming white Gaussian noise. For channels having bursty error characteristics, parameters indicating the burstiness, such as average burst error duration or length, standard deviation of bit errors, and/or probabilities for a Gilbert-Elliot model, could be used. A range of error resilience strengths with unspecified meaning could be applied. In this case, e.g. a range from 0 to 10, 0 representing minimum or no error resilience, and 10 indicating the maximum achievable error resilience could be used.

It is noted that the invention may relate to signalling from the receiving module 106 to the sending module 104 the required error resilience strength depending on the application running in the runtime environment 132 of the receiving module 106. An implicit channel quality feedback, depending on channel properties on the network 102 may not be considered.

According to the invention, the receiving module 106 can signal the sending module 104 a desired error resilience strength that may be completely unrelated to the channel conditions, regardless of the number of segments and the complexity of the (end-to-end) channel.

It is also possible to employ Session Description Protocol (SDP) syntax when sending (208) data representative of the operation point from the receiving module 106 to the sending module 104. For example, the receiving module 106 defines the operation point for content encoding in the sending module 104 such that it would like to receive a bit stream that is tolerant to 5% of packet losses.

An SDP attribute requested_plr_protection denoting the packet loss rate against which the transmitted stream should be protected, in order to reconstruct an acceptable video quality in the receiving module, could be send (208).

For example, in a video conferencing system, sending module 104 wishes to setup a call and therefore sends an initial SIP INVITE message with SDP body as given below

v=0

o=NRC 289084412 2890841235 IN IP4 123.124.125.1

s=Demo

c=IN IP4 123.124.125.1

m=video 5001 RTP/AVP 99

a=rtpmap 99H2.63/90000

m=audio 6001 RTP/AVP 32

a=rtpmap:32 AMR

to receiving module 106.

After having received this invitation message, receiving module 106 starts (202) its applications. The running application is determined (204) and based on prevailing radio conditions it estimates that the transmitted streams should be protected against 5% packet loss rate. This allows defining (206) the operation point of the codec in the sending module 104. The data representative of the codec can be send (208) in an SDP message with

v=0

o=NRC 289084412 2890841235 IN IP4 123.124.125.1

s=Demo

c=IN IP4 172.19.12.127

m=video 5001 RTP/AVP 99

a=rtpmap 99H2.63/90000

a=plr_protection:5

m=audio 6001 RTP/AVP 98

a=rtpmap:98 AMR

a=plr_protection:5

The sending module receives (210) this message with the SDP attribute of plr_protection. It obtains (212) content from the acquisition unit 116 and encodes the obtained content in coding unit 144 according to required packed loss rate of 5%. The encoded content, which is now forward error protected against 5% packet loss rate, is sent (216) to the receiving module 106, which receives the encoded content (218). The content is decoded (220) in-line with the specified operation point of the encoder in decoding unit 128 and presented (222).

In some embodiments of the invention the receiving unit 106 advises the sending unit 104 in the form of an Abstract Application Definition (AAD) messages about the requested operation point for encoding. The AAD could be declared as an SDP attribute, which can be carried during the session setup. The SDP attribute can assume values defining the application that the bit stream is intended for.

Some examples of the applications are videoconference, streaming over a wireless network, streaming over a wireline network, streaming in an error free environment, local recording, DVD compliant recording and playback. A summation of the properties for an application is henceforth referred to as an Application Profile. Therefore, examples of Applications Profiles may comprise “videoconference”, “Streaming_over_wireless”, “streaming_over_wireline”, “streaming_error_free”, “Local_recording”, “DVD_compliant”, and any others possible descriptions.

Sending module 104 and receiving module 106 need to have a common understanding of the properties of each of those application profiles, e.g. in terms of latency, error resilience, need for good video resolution or high video frame-rate, and others. The common understanding may be pre-agreed in a standard, or it may equally be possible to convey information intended to establish the common understanding over the network 102, before an AAD message is being sent.

In the systems known in the prior art, the Application Profile of sender and receiver are identical, and fixed. When, for example, two video conferencing systems connect each other, then the Application profile is “Videoconference”. When a streaming server in a 3GPP environment connects to a streaming client, then the Application Profile may be “Streaming_over_wireless”. In this case, sending an AAD message indicating the desired Application Profile, is redundant.

However, if the receiving module 106 desires video streams optimized for another application, it can send an AAD indicating the appropriate Application Profile. The receiving module 106 transmits (208, 210) the AAD to the sending module 104, either once during connection setup or dynamically during the session. The sending unit may react by encoding (214) the bit stream to be sent (216) according to its interpretation of the Application Profile carried in the AAD.

As illustrated in FIG. 2 and described by various embodiments, the data representative of the operation point may be sent only once per session as part of the connection setup or capability exchange.

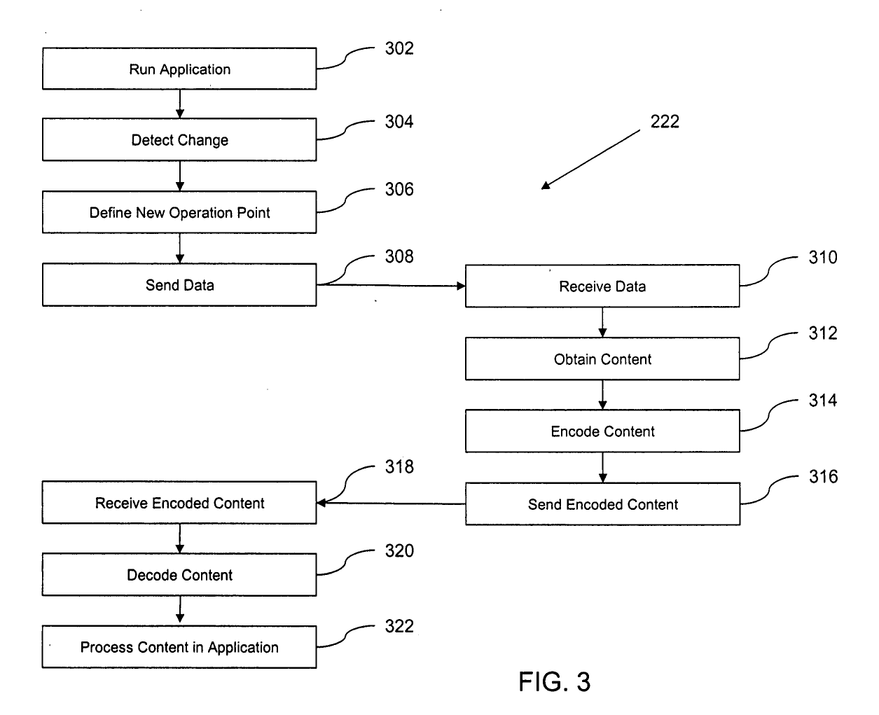

However, the data representative of the operation point may also be sent dynamically during the lifetime of a connection, as will be illustrated in FIG. 3. During the normal operation (302) of the application the type or needs of application may change.

One example for this scenario may consist of two video conferencing systems (104, 106) that are initially used for interactive, human communication (video call). After a period of time, the user at the receiving module may switch on a video recorder to capture, in high quality, a movie that the sender is splicing in.

This change can be determined (304) within the receiving module 106. The change of use of the received content influences the operation point for the codec. This new operation point is defined (306) and sent (308) to the sending module 104.

There are two ways the receiving module 106 can signal the new operation point, i.e. the new delay requirements, to the sending module 104 during mid-call. One is using a SIP re-invite message and sending a modified SDP with the APP_DELAY attribute. Another option would be to use RTCP. RTCP, for example defined in the IETF RFC 3550, can provide feedback information to sending module 104 and receiving module 106 about the quality of the transmission link. RTCP can define different types of packets types to carry a variety of control information like Sender Reports, Receiver Reports, Source Description, BYE and APP packets. The application delay value could be signalled in one of these RTCP packet types, specifically in a Receiver Report or an Application Specific (APP) packet, during the life of the session.

The sending module 104 can receive via receiving unit 112, while sending encoded content via sending unit 110, the new data representative of the operation point. This new information may be conveyed to the coding unit 114, upon which the coding unit 114 changes the operation point of the used codec, and continues coding (314) the content.

The encoded content is sent (316) via sending unit 110 to receiving module 106, which receives (318) the encoded content. The decoding unit 128 operates at the new operation point and decodes (320) the content, which may now be used (322) for a different application.

The present application provides improved coding of content depending on application using the content. The receiving side may define the encoding parameters and may inform the content provider about the required encoding parameters.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps, which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. It should also be recognized that any reference signs should not be constructed as limiting the scope of the claims.

What is claimed is:

1. A method for receiving encoded content, the method comprising:
determining at least at
A) the beginning of content transmission,
B) dynamically during content transmission, an operation point for encoded content depending on the application receiving the content, wherein determining an operation point for encoding content comprises defining at least one parameter specifying the application,
sending data representative of the determined operation point to a sender of the content, and
receiving the encoded content wherein the encoding is based on the operation point.

2. The method of claim 1, wherein the operation point defines at least one of the following encoding parameters:
A) maximum latency;
B) maximum error resilience;
C) forward error correction code;
D) maximum buffering delay;
E) bitrate;
F) jittering;
G) order of decoded data in output order.

3. The method of claim 1, wherein sending the data representative of the determined operation point comprises sending a message in a format of a session description protocol.

4. The method of claim 1, wherein sending the data representative of the determined operation point comprises sending at least one packet of the following RTCP packet types:
A) RTCP Receiver Report packet comprising information of the determined operation point,
B) RTCP APP packet comprising information of the determined operation point.

5. The method of claim 1, wherein sending the data representative of the determined operation point comprises sending a value descriptive of the overall delay at the receiving application.

6. The method of claim 1, wherein determining the operation point is independent of channel conditions.

7. The method of claim 1, wherein receiving the encoded content comprises receiving source encoded content.

8. The method of claim 1, wherein receiving the encoded content comprises receiving packetized content.

9. The method of claim 1, wherein the data representative of an operation point is in the form of an Abstract Application Definition (AAD) message.

10. The method of claim 9, wherein semantics of the AAD comprise at least one of the following encoding parameters:
A) maximum latency;
B) maximum error resilience;
C) forward error correction code;
D) maximum buffering delay;
E) bitrate;
F) jittering;
G) order of decoded data in output order.

11. The method of claim 9, wherein semantics of the AAD is known at both a sender and the receiver, before the data representative of an operation point is being received by the sender.

12. The method of claim 9, wherein semantics of the AAD is negotiated between a sender and the receiver before the data representative of an operation point is being received by the sender.

13. A method for sending encoded content, the method comprising:
a sender receiving data representative of an operation point for encoded content depending on the application receiving the content, the data representative of the operation point comprising at least one parameter specifying the application,
adapting encoding of the content depending on the received data representative of the operation point,
encoding the content based on the operation point, and
sending the encoded content to the receiver.

14. The method of claim 13, wherein the operation point defines at least one of the following encoding parameters:
A) maximum latency;
B) maximum error resilience;
C) forward error correction code;
D) maximum buffering delay;
E) bitrate;
F) jittering;
G) order of decoded data in output order.

15. The method of claim 13, wherein receiving data representative of the operation point comprises receiving a message in a format of a session description protocol.

16. The method of claim 13, wherein receiving data representative of the operation point comprises receiving at least one packet of the following RTCP packet types:
A) RTCP Receiver Report packet comprising information of the operation point
B) RTCP APP packet comprising information of the operation point

17. The method of claim 13, wherein receiving data representative of the operation point comprises receiving a value descriptive of the overall delay at the receiving application.

18. The method of claim 13, wherein the operation point is independent of channel conditions.

19. The method of claim 13, wherein sending the encoded content comprises sending source encoded content.

20. The method of claim 13, wherein sending the encoded content comprises sending packeted content.

21. The method of claim 13, wherein the data representative of an operation point is in the form of an Abstract Application Definition (AAD) message.

22. The method of claim 21, wherein semantics of the AAD comprise at least one of the following encoding parameters:
A) maximum latency;
B) maximum error resilience;
C) forward error correction code;
D) maximum buffering delay;
E) bitrate;
F) jittering;
G) order of decoded data in output order.

23. The method of claim 21, wherein semantics of the AAD is known at both a sender and the receiver, before the data representative of an operation point is being received by the sender.

24. The method of claim 21, wherein semantics of the AAD are negotiated between a sender and the receiver before the data representative of an operation point is being received by the sender.

25. A method for transmitting content with:
determining within a receiver of content at least at
A) the beginning of content transmission,
B) dynamically during content transmission, an operation point for encoded content depending on the application receiving the content, wherein determining an operation point for encoding content comprises defining at least one parameter specifying the application,
sending data representative of the chosen operation point to a sender of the content,
receiving within a sender of content the data representative of an operation point for encoded content depending on the application receiving the content, the data representative of the operation point comprising the at least one parameter specifying the application,
adapting encoding of the content depending on the received data representative of the operation point,
encoding the content based on the operation point,
sending the encoded content to the receiver, and
receiving in the receiver the encoded content wherein the encoding is based on the operation point.

26. An electronic device for receiving encoded content comprising:
an application detection unit for determining at least at
A) the beginning of content transmission,
B) dynamically during content transmission, an operation point for encoded content depending on the application receiving the content, wherein determining an operation point for encoding content comprises defining at least one parameter specifying the application,
a sending unit for sending data representative of the determined operation point to a sender of the content, and
a reception unit for r receiving the encoded content wherein the encoding is based on the operation point.

27. The device of claim 26, wherein the application detection unit determines the operation point with at least one of the following encoding parameters:
A) maximum latency;
B) maximum error resilience;
C) forward error correction code;
D) maximum buffering delay;
E) bitrate;
F) jittering;
G) order of decoded data in output order.

28. The device of claim 26, wherein the sending unit sends a message in a format of a session description protocol for sending data representative of the determined operation point.

29. The device of claim 26, wherein the sending unit sends at least one packet of the following RTCP packet types:
A) RTCP Receiver Report packet comprising information of the determined operation point,
B) RTCP APP packet comprising information of the determined operation point for sending data representative of the determined operation point.

30. The device of claim 26, wherein the detection unit determines the data representative of the operation point in the form of an Abstract Application Definition (AAD) message.

31. The device of claim 30, wherein semantics of the AAD comprise at least one of the following encoding parameters:
A) maximum latency;
B) maximum error resilience;
C) forward error correction code;
D) maximum buffering delay;
E) bitrate;
F) jittering;
G) order of decoded data in output order.

32. The device of claim 30, wherein semantics of the AAD is known at both a sender and the receiver, before the data representative of an operation point is being received by the sender.

33. The device of claim 30, wherein semantics of the AAD is negotiated between a sender and the receiver before the data representative of an operation point is being received by the sender.

34. An electronic device for sending encoded content comprising:
a receiving unit for receiving data representative of an operation point for encoded content depending on the application receiving the content, the data representative of the operation point comprising at least one parameter specifying the application,
an encoding unit for adapting encoding of the content depending on the received data representative of the operation point, and
a sending unit for sending the encoded content to the receiver.

35. The device of claim 34, wherein the operation point defines at least one of the following encoding parameters:
A) maximum latency;
B) maximum error resilience;
C) forward error correction code;
D) maximum buffering delay;
E) bitrate;
F) jittering;
G) order of decoded data in output order.

36. The device of claim 34, wherein the receiving unit is arranged for receiving a message in a format of a session description protocol for the data representative of the operation point.

37. The device of claim 34, wherein the receiving unit is arranged for receiving at least one packet of the following RTCP packet types:
A) RTCP Receiver Report packet comprising information of the operation point
B) RTCP APP packet comprising information of the operation point,
for receiving data representative of the operation point.

38. The device of claim 34, wherein the data representative of an operation point is in the form of an Abstract Application Definition (AAD) message.

39. The device of claim 38, wherein semantics of the AAD comprise at least one of the following encoding parameters:
A) maximum latency;
B) maximum error resilience;
C) forward error correction code;
D) maximum buffering delay;
E) bitrate;
F) jittering;
G) order of decoded data in output order.

40. The device of claim 38, wherein semantics of the AAD is known at both a sender and the receiver, before the data representative of an operation point is being received by the sender.

41. The device of claim 38, wherein semantics of the AAD are negotiated between a sender and the receiver before the data representative of an operation point is being received by the sender.

42. A computer program product comprising one or more machine-readable media that store instructions which, when executed, cause one or more machines to receive encoded content, the instructions causing the one or more machines to:
determine at least at
A) the beginning of content transmission,
B) dynamically during content transmission, an operation point for encoded content depending on the application receiving the content, wherein determining an operation point for encoding content comprises defining at least one parameter specifying the application,
send data representative of the determined operation point to a sender of the content, and
receive the encoded content wherein the encoding is based on the operation point.

43. The computer program product of claim 42, wherein the operation point defines at least one of the following encoding parameters:
A) maximum latency;
B) maximum error resilience;
C) forward error correction code;
D) maximum buffering delay;
E) bitrate;
F) jittering;
G) order of decoded data in output order.

44. The computer program product of claim 42, the instructions causing the one or more machines to send a message in a format of a session description protocol when sending data representative of the determined operation point comprises.

45. The computer program product of claim 42, the instructions causing the one or more machines to send at least one packet of the following RTCP packet types:
A) RTCP Receiver Report packet comprising information of the determined operation point,
B) RTCP APP packet comprising information of the determined operation point,
when sending data representative of the determined operation point comprises

46. The computer program product of claim 42, the instructions causing the one or more machines to form the data representative of an operation point in the form of an Abstract Application Definition (AAD) message.

47. The computer program product of claim 42, wherein semantics of the AAD comprise at least one of the following encoding parameters:
A) maximum latency;
B) maximum error resilience;
C) forward error correction code;
D) maximum buffering delay;
E) bitrate;
F) jittering;
G) order of decoded data in output order.

48. The computer program product of claim 46, wherein semantics of the AAD is known at both a sender and the receiver, before the data representative of an operation point is being received by the sender.

49. The computer program product of claim 46, wherein semantics of the AAD is negotiated between a sender and the receiver before the data representative of an operation point is being received by the sender.

50. A computer program product comprising one or more machine-readable media that store instructions which, when executed, cause one or more machines to send encoded content, the instructions causing the one or more machines to:
receive receiving data representative of an operation point for encoded content depending on the application receiving the content, the data representative of the operation point comprising at least one parameter specifying the application,
adapt encoding of the content depending on the received data representative of the operation point,
encode the content based on the operation point, and
send the encoded content to the receiver.

51. The computer program product of claim 50, wherein the operation point defines at least one of the following encoding parameters:
A) maximum latency;
B) maximum error resilience;
C) forward error correction code;
D) maximum buffering delay;
E) bitrate;
F) jittering;
G) order of decoded data in output order.

52. The computer program product of claim 50, the instructions causing the one or more machines to receive a message in a format of a session description protocol for the data representative of the operation point.

53. The computer program product of claim 50, the instructions causing the one or more machines to receive at least one packet of the following RTCP packet types:
A) RTCP Receiver Report packet comprising information of the operation point
B) RTCP APP packet comprising information of the operation point,
when receiving data representative of the operation point.

54. The computer program product of claim 50, wherein the data representative of an operation point is in the form of an Abstract Application Definition (AAD) message.

55. The computer program product of claim 54, wherein semantics of the AAD comprise at least one of the following encoding parameters:
A) maximum latency;
B) maximum error resilience;
C) forward error correction code;
D) maximum buffering delay;
E) bitrate;
F) jittering;
G) order of decoded data in output order.

56. The computer program product of claim 54, wherein semantics of the AAD is known at both a sender and the receiver, before the data representative of an operation point is being received by the sender.

57. The computer program product of claim 54, wherein semantics of the AAD are negotiated between a sender and the receiver before the data representative of an operation point is being received by the sender.

58. A system for transmitting content comprising:
an electronic device for receiving encoded content comprising:
an application detection unit for determining at least at
A) the beginning of content transmission,
B) dynamically during content transmission, an operation point for encoded content depending on the application receiving the content, wherein determining an operation point for encoding content comprises defining at least one parameter specifying the application,
a sending unit for sending data representative of the determined operation point to a sender of the content, and
a reception unit for r receiving the encoded content wherein the encoding is based on the operation point, and
an electronic device for sending the encoded content comprising:
a receiving unit for receiving data representative of an operation point for encoded content depending on the application receiving the content, the data representative of the operation point comprising at least one parameter specifying the application,
an encoding unit for adapting encoding of the content depending on the received data representative of the operation point, and
a sending unit for sending the encoded content to the receiver.

59. The system of claim of claim 58, wherein the application detection unit determines the operation point with at least one of the following encoding parameters:
A) maximum latency;
B) maximum error resilience;
C) forward error correction code;
D) maximum buffering delay;
E) bitrate;
F) jittering;
G) order of decoded data in output order.

60. The system of claim 58, wherein the sending unit sends a message in a format of a session description protocol for sending data representative of the determined operation point.

61. The system of claim 58, wherein the sending unit sends at least one packet of the following RTCP packet types:
A) RTCP Receiver Report packet comprising information of the determined operation point,
B) RTCP APP packet comprising information of the determined operation point
for sending data representative of the determined operation point.

62. The system of claim 58, wherein the detection unit determines the data representative of the operation point in the form of an Abstract Application Definition (AAD) message.

63. The system of claim 58, wherein semantics of the AAD comprise at least one of the following encoding parameters:
A) maximum latency;
B) maximum error resilience;
C) forward error correction code;
D) maximum buffering delay;
E) bitrate;
F) jittering;
G) order of decoded data in output order.

64. The system of claim 58, wherein semantics of the AAD is known at both the sender and the receiver, before the data representative of an operation point is being received by the sender.

65. The system of claim 58, wherein semantics of the AAD is negotiated between the sender and the receiver before the data representative of an operation point is being received by the sender.

66. The system of claim 58, wherein the receiving unit is arranged for receiving a message in a format of a session description protocol for the data representative of the operation point.

67. The system of claim 58, wherein the receiving unit is arranged for receiving at least one packet of the following RTCP packet types:
A) RTCP Receiver Report packet comprising information of the operation point
B) RTCP APP packet comprising information of the operation point,
for receiving data representative of the operation point.
